(19) United States
(12) Patent Application Publication
(10) Pub. No.: US 2003/0142686 A1
(43) Pub. Date: Jul. 31, 2003

(54) Preamble searching apparatus and method

(76) Inventor: Joo-Deog Kim, Kyeonggi-Do (KR)

Correspondence Address: CANTOR COLBURN, LLP, 55 GRIFFIN ROAD SOUTH, BLOOMFIELD, CT, 06002

(21) Appl. No.: 10/343,377

(22) PCT Filed: Sep. 29, 2001
(86) PCT No.: PCT/KR01/01646

(30) Foreign Application Priority Data
Oct. 6, 2000 (KR) 2000/58874

(51) Int. Cl. H04L 12/56

(52) U.S. Cl. 370/418; 370/335

(57) ABSTRACT

An apparatus and method for searching for preambles in a base station of a mobile telecommunications system employing a CDMA system. The method comprises the steps of inputting oversampled samples of each chip associated with a first antenna from an access slot boundary and storing the inputted samples in a first buffer, inputting oversampled samples of each chip associated with a second antenna after the lapse of a predetermined delay from the access slot boundary and storing the inputted samples in a second buffer, reading samples in a period of a plurality of chips from the first and second buffers and correlating the read samples with scramble codes to generate signatures corresponding respectively to a plurality of hypotheses, calculating an accumulated energy value of each of the signatures, and sorting the signatures by identical ones and selecting one with a maximum accumulated energy value from among the sorted signatures.

### TECHNICAL FIELD

The present invention relates to a mobile telecommunications system employing a code division multiple access (CDMA) system, and more particularly to a preamble searching apparatus and method which can simplify a device design required for acquiring a number of transmitted signals in a base station.

### BACKGROUND ART

Recently, IMT-2000 (International Mobile Telecommunication 2000) has been in the spotlight as the leading integrated technique for providing communication services in the 21st century. As such, much research is actively conducted into standardization and implementation technologies for IMT-2000 around the world. The researches on the standardization of IMT-2000 are focused on CDMA-based mobile telecommunications technologies. Research is being done on implementation technologies to provide various services and create a high transmission rate, which are both required by the IMT-2000, based on the CDMA techniques.

There are a variety of techniques used to enable a CDMA-based mobile telecommunications service. One of the most essential technologies, which are capable of providing mobile telecommunications service, is concerned with the acquisition of a CDMA signal sent from a transmitter to a receiver. When the CDMA signal arrives at the receiver, the receiver must perform CDMA signal acquisition to establish a signal transmission path from the transmitter to the receiver. It is impossible to carry out an exchange of a CDMA signal between, for example, a mobile terminal and a base station if the CDMA signal acquisition is not performed. In this regard, it may safely be said that CDMA signal acquisition in a receiver is very important in the CDMA-based mobile telecommunications.

A receiver performs the acquisition of a CDMA signal over several steps. At the first step, the receiver acquires initial signals (that is, preamble signals) from a transmitter. The transmitter generates a CDMA signal using predefined codes known to both of it and the receiver. If the transmitter generates the CDMA signal using some code unknown to the receiver and transmits it to the receiver, it is impossible for the receiver to receive the CDMA signal. In order to normally acquire the CDMA signal from the transmitter, the receiver must previously know which codes are used for generating the CDMA signal. However, if a number of CDMA signals are transmitted by several different transmitters to the receiver, it is difficult for the receiver to perform the CDMA signal acquisition operation at the first step, since the receiver does not know which CDMA signals to receive.

To solve this problem, the transmitter must generate a CDMA signal using predefined codes known to it and the receiver and transmit the generated CDMA signal to the receiver. Further, the transmitter must generate the CDMA signal in a predefined format and transmit it at a predefined timing to the receiver. However, another problem may exist in performing the CDMA acquisition operation in this way. The problem may occur when several transmitters transmit initial CDMA signals at the same time, respectively. That is, if the several transmitters generate CDMA signals using the same codes and then transmit them to a receiver, the receiver may be confused as to which CDMA signals to receive. This phenomenon is referred to as signal collision. It is desirable to avoid signal collision. To prevent signal collision, the transmitters use predefined different codes for generating the respective CDMA signals, where each of the codes is known to the receiver. Even though the transmitters transmit the CDMA signals simultaneously to the receiver, the probability of signal collision occurring can be reduced because each of the CDMA signals is generated through the different codes. This is made possible on the assumption that the receiver is able to simultaneously receive all of the CDMA signals corresponding respectively to the codes. However, this results in increased complexity of hardware implementation.

Generally, a correlator of a receiver plays a key role in a CDMA signal acquisition operation. The correlator multiplies CDMA signals and reference signals stored in the receiver, and accumulates the resulting values for a given time. The correlator outputs a large accumulated value if the receiver succeeds in acquiring a CDMA signal. It is possible to determine whether to acquire the CDMA signal based on the output of the correlator. If the receiver fails to acquire the CDMA signal, the correlator changes the start time of the CDMA signal and performs a correlation operation again using a new start time. This process is repeated over several start times within a predetermined range. The reference signals stored in the receiver are predefined codes, which are used by a transmitter for generating the CDMA signals and known to both of the receiver and transmitter. If several different codes are used for generating CDMA signals to reduce the probability of signal collision, several different correlators corresponding respectively to the codes are needed for the CDMA signal acquisition. For this reason, the hardware implementation inevitably entails increased complexity.

However, it is necessary to reduce the time needed for the CDMA signal acquisition in order to satisfy requirements of the IMT-2000, that is efficient data service and high data transmission rate. Namely, it is necessary to minimize the time spent in completing the initial signal acquisition, as well as to reduce the probability of signal collision. The time limit for acquiring the initial CDMA signals from the transmitters is specified in the Standard Recommendation of the IMT-2000. It is impossible to acquire the CDMA signals within the limited time if the above-mentioned correlators are used. In order to acquire the CDMA signals within a predetermined time, the correlators have to check a start time of each of the CDMA signals at the same time. However, this will certainly result in an increase in the number of the correlators. Therefore, the initial signal acquisition can hardly be completed within the time limit using the correlators.

In this regard, a CDMA signal acquisition device having a construction of a matched filter is required. The above-mentioned limitation can be overcome through the matched filter which makes the above correlator perform multiplications and accumulations over a given period of time all at once. The matched filter, however, needs an operational unit which is capable of repeatedly performing the multiplications and additions the predetermined number of times for a given time all at once, and a memory to assist in these operations. The multiplications and additions are performed in connection with a specific code. If several codes is used to generate CDMS signals, several matched filters are required correspondingly to the several codes to perfrom CDMA signal acquisition. For this reason, the hardware implementation entails a complexity increase similar to that of using a number of correlators.

In order to satisfy the requirements of the IMT-2000, it is necessarily required to introduce a new CDMA signal acquisition device for acquiring CDMA signals within a limited time. As described above, the CDMA signal acquisition device consisting of a number of conventional matched filters has a disadvantage in that the complexity of the hardware implementation thereof is excessively increased. Therefore, a new matched filter is required which is capable of reducing the complexity. That is, it is necessary to analyze the cause of the high complexity and develop a device to reduce it.

### DISCLOSURE OF THE INVENTION

Therefore, the present invention has been made in view of the above problems, and it is an object of the present invention to provide an apparatus and method for searching for preambles, which can normally acquire transmitted signals, while having a structure configured to lessen the heavy dependence of a matched filter on operational unit and memory, and process several different codes with only one matched filter, thereby reducing a complexity of a hardware implementation of a conventional matched filter.

It is another object of the present invention to provide an apparatus and method for searching for preambles, which can acquire transmitted signals within a limited time required by IMT-2000 with a simpler construction.

In accordance with one aspect of the present invention, the above and other objects can be accomplished by the provision of a method for searching for preambles to acquire a transmitted signal, comprising the steps of inputting oversampled samples of each chip associated with a first antenna from an access slot boundary and storing the inputted samples in a first buffer; inputting oversampled samples of each chip associated with a second antenna after the lapse of a predetermined delay from the access slot boundary and storing the inputted samples in a second buffer; reading samples in a period of a plurality of chips from the first and second buffers and correlating the read samples with scramble codes to generate signatures corresponding respectively to a plurality of hypotheses; calculating an accumulated energy value of each of the signatures; and sorting the signatures by identical ones and selecting one with a maximum accumulated energy value from among the sorted signatures.

In accordance with another aspect of the present invention, there is provided a method for searching for preambles to acquire a transmitted signal, comprising the steps of inputting oversampled samples of each chip associated with an antenna from an access slot boundary and storing the inputted samples in a sample buffer; reading samples in a period of a plurality of chips from the sample buffer and correlating the read samples with scramble codes to generate signatures corresponding respectively to a plurality of hypotheses; calculating an accumulated energy value of each of the signatures; and sorting the signatures by identical ones and selecting one with a maximum accumulated energy value from among the sorted signatures.

In accordance with yet another aspect of the present invention, there is provided an apparatus for searching for preambles in a mobile telecommunications system employing a code division multiple access system, comprising a first buffer for inputting oversampled samples of each chip associated with a first antenna from an access slot boundary and storing the inputted samples circularly for a plurality of correlation periods; a second buffer for inputting oversampled samples of each chip associated with a second antenna after the lapse of a predetermined delay from the access slot boundary and storing the inputted samples only for a specific one of the correlation periods; a sample transmitter for reading samples in a period of a plurality of chips from the first and second buffers and transmitting the read samples as a plurality of sample patterns corresponding respectively to a plurality of hypotheses; a scramble code transmitter for generating scramble codes at intervals of an access slot and transmitting the generated scramble codes as a plurality of scramble code patterns corresponding respectively to the plurality of hypotheses at intervals of the plurality of chips; a plurality of correlators for correlating the samples from the sample transmitter with the scramble codes from the scramble code transmitter to generate signatures corresponding respectively to the hypotheses; an energy calculation unit for calculating an accumulated energy value of each of the signatures from the correlators; and a sort/select unit for sorting the signatures from the correlators by identical ones and selecting one with a maximum accumulated energy value from among the sorted signatures.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view showing the structure of a random access burst based on wideband code division multiple access (WCDMA);

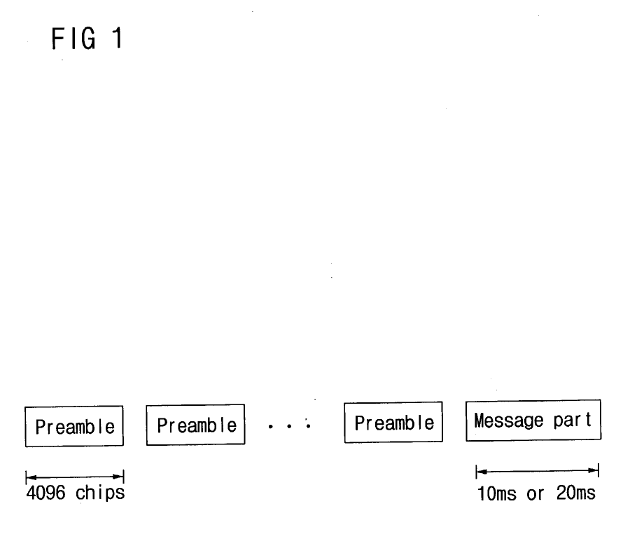

FIG. 2 is a block diagram showing the construction of an apparatus for searching for preambles based on WCDMA according to the present invention;

FIG. 3 is a detailed block diagram showing the construction of the sample buffer of FIG. 2;

FIG. 4 is a view illustrating a write operation of the sample buffer of FIG. 2;

FIG. 5 is a block diagram of a surrounding construction of the sample buffer of FIG. 2;

FIG. 6 is a detailed block diagram showing the construction of the sample transmitter of FIG. 2 according to the present invention;

FIG. 7 is a detailed block diagram showing the construction of the scramble code transmitter of FIG. 2 according to the present invention;

FIG. 8 is a view illustrating an operation of correlating a sample associated with a single antenna with scramble codes;

FIG. 9 is a view illustrating an operation of correlating samples associated with two antennas with scramble codes;

FIG. 10 is a detailed block diagram showing the construction of one of the correlators of FIG. 2 according to the present invention;

FIG. 11 is a detailed block diagram showing the construction of the energy calculation unit of FIG. 2 according to the present invention; and

FIG. 12 is a detailed block diagram showing the construction of the sort/select unit of FIG. 2 according to the present invention.

### BEST MODE FOR CARRYING OUT THE INVENTION

Preferred embodiments of the present invention will be described in detail with reference to the annexed drawings. In the following description of the present invention, a detailed description of known functions and configurations incorporated herein will be omitted when it may make the subject matter of the present invention rather unclear. Also, numbers used in the following description are provided as examples only, and are supported by IMT-2000 based on asynchronous CDMA technologies. Various modifications to the preferred embodiment will be readily apparent to those skilled in the art, and the generic principles defined herein may be applied to other CDMA signals having similar formats to that of CDMA signal of the preferred embodiment of the present invention without departing from the spirit and scope of the invention.

For reference, in CDMA-based mobile telecommunications, a CDMA signal is transmitted to a receiver over an access channel for acquisition of an initial signal of the CDMA signal. The access channel has a start time in units of a time slot of constant length. This unit of time is called an access slot. A first transmitted part of the access channel is called a preamble. The initial signal acquisition in the receiver can be achieved by acquiring the preamble of the access channel. The transmitter generates the preamble signals using a code selected from among a group consisting of several selectable codes. Each of the codes is generally called a signature. The receiver acquires each of the initial signals at once, which initial signals are generated using several different signatures. By doing so, even though transmitters generate preamble signals using different signatures and transmit them to the receiver, respectively, the receiver can acquire every preamble signal from each of the transmitters. Therefore, a matched filter introduced in the present invention may be named a preamble searching apparatus because it can acquire initial signals which are generated with all usable signatures.

Hereinafter, a detailed description will be given of the matched filter.

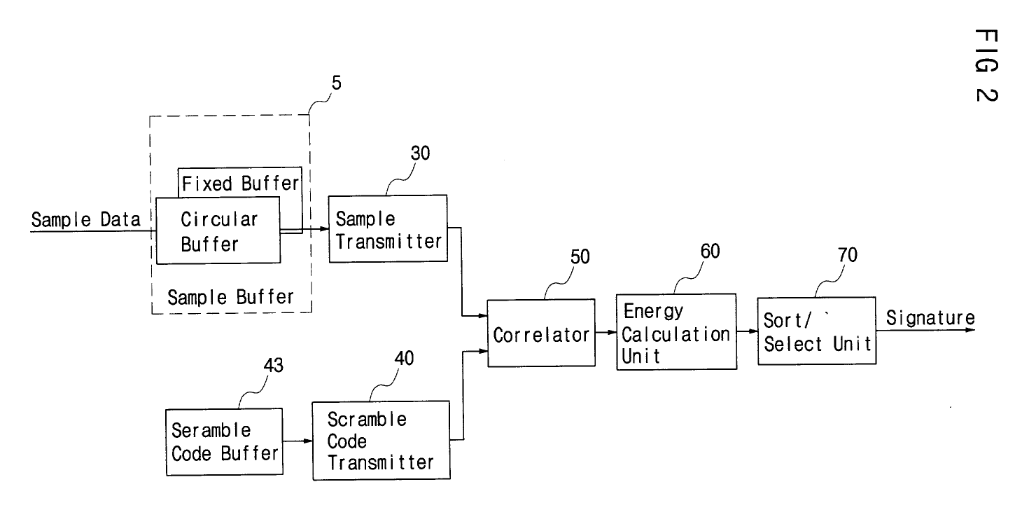

FIG. 2 is a block diagram schematically showing the construction of a preamble searching apparatus used in a base station based on wideband code division multiple access (WCDMA) technologies according to the present invention. The preamble searching apparatus comprises a sample buffer 5 having a circular buffer and fixed buffer, sample transmitter 30, scramble code transmitter 40, correlator 50, energy calculation unit 60 and sort/select unit 70.

Digital data from a transmitter is received through a wireless reception unit and intermediate frequency demodulation unit of the base station. The received digital data is inputted to a channel board and then stored in the sample buffer 5 at a rate of 2 samples per chip associated with a sector and antenna designated by a DSP. The DSP is a functional block mounted in the channel board. This DSP is well known to those skilled in the art and, therefore, not shown.

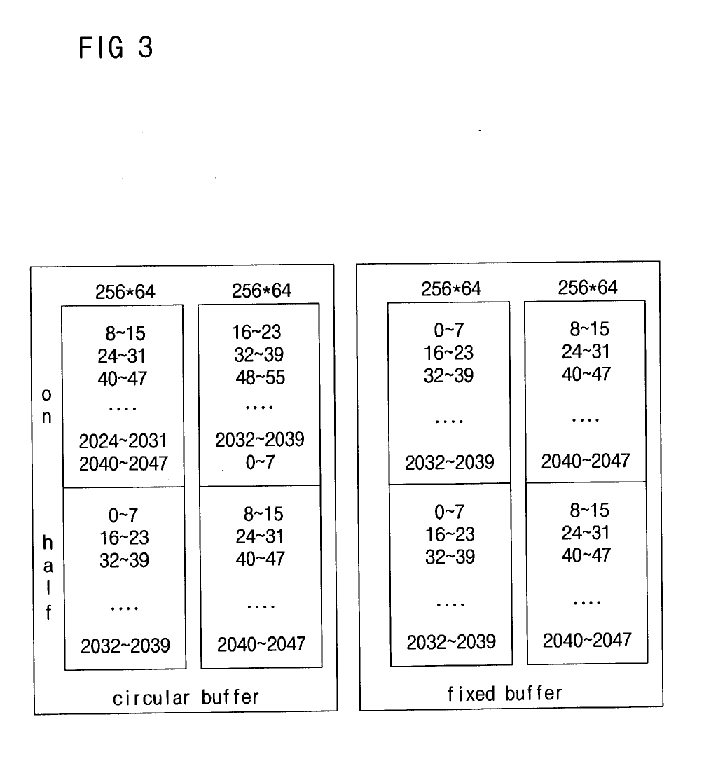

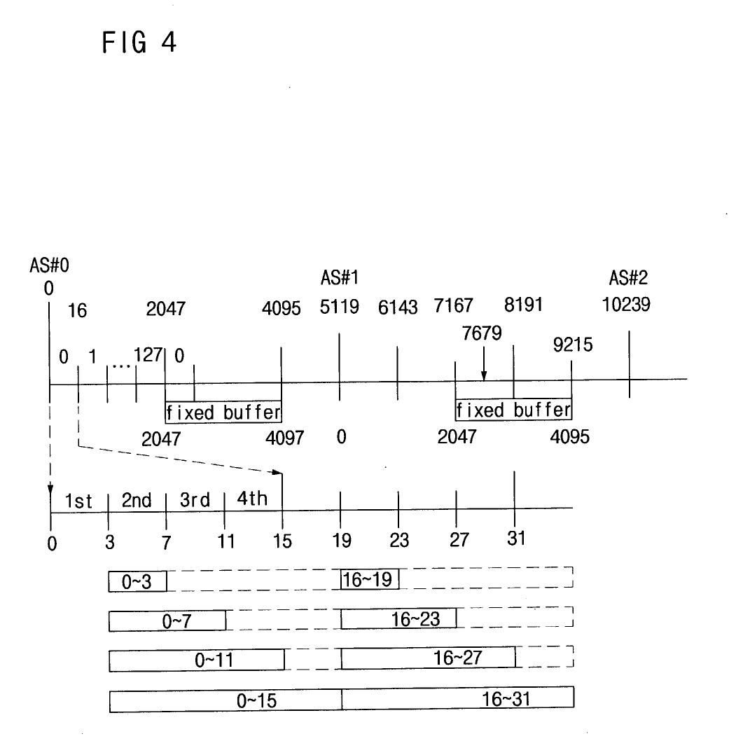

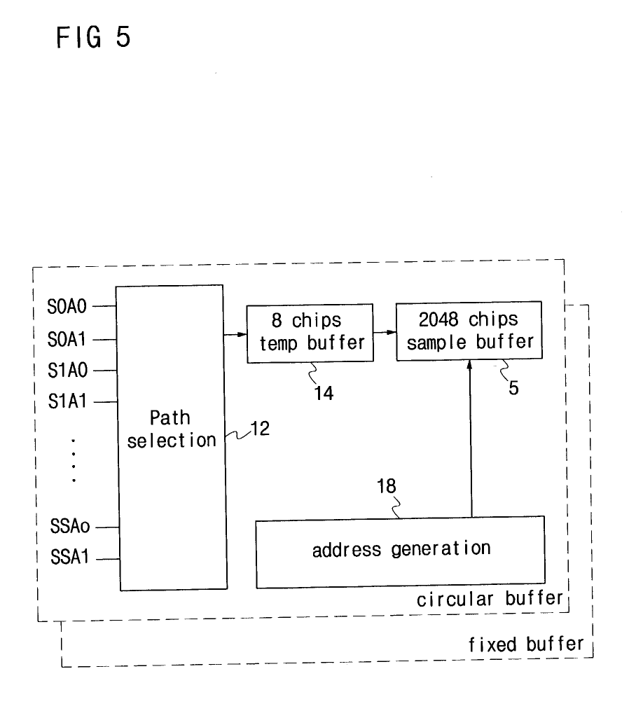

On the other hand, a preamble search operation begins to be performed at the boundary of an access slot for the designated sector and antenna. The sample buffer 5 has the circular buffer and fixed buffer, as shown in FIG. 3, to perform the preamble search operation in 2-antenna search mode which is one of preamble search modes. The circular buffer circularly stores samples in a period of 2048 chips from the access slot boundary, and the fixed buffer stores only samples in a period of 2048 chips subsequent to the above 2048-chip period from the access slot boundary. Each of the buffers, as shown in FIG. 3, stores samples in 2048-chip periods in units of 16-chip periods in every row, and has a capacity of 32768 bits (2048 chips×2 samples/chip×8 bits/sample). Each of the buffers has two separate memories, or banks. One of the two memories stores samples from 0 to 7 and the other stores samples from 8 to 15, in the case of modulo 16. Each buffer size of the banks is 256×64 bits. This structure is equally applied to both the circular buffer and fixed buffer, with the exception that the fixed buffer stores only samples in a period from the end point of the 2048-chip period from the access slot boundary to the 4096^{th} chip from the access slot boundary. A description will be given of a procedure of storing samples in the sample buffer 5 below. First, samples in a 16-chip period are stored in the first row. As shown in FIG. 4, a write operation is performed four times for the 16-chip period and valid data in the 16-chip period is stored in succession. In the circular buffer, half-time samples are stored in 8 chips advanced format, compared to on-time samples. In the fixed buffer, half-time and on-time samples are stored in the same format. An address generation operation to store samples in the circular buffer is repeated at intervals of an access slot and initialized at every access slot boundary. For this storage operation, it is necessary to provide a temporary buffer 14 in the front of the sample buffer 5, in which the temporary buffer 14 temporarily stores samples to a maximum of an 8-chip period, as shown in FIG. 5. FIG. 4 is a view illustrating a storage operation of the sample buffer for storing samples in every 16-chip period, inputted through the temporary buffer 14, in the sample buffer 5 in units of 4-chip periods. Addresses used to store theses samples in the sample buffer 5 are generated in accordance with the following equation:

Ad_Wr(cir)=[((cnt_chipx1_{—}2as−8)/16) % 128] for on-time samples=[(cnt_chipx1_{—}2as/16) % 128]+128 for half-time samples where, cnt_chipx1_{—}2as=0˜10239

Ad_Wr(fix)=[(cnt_chipx1_as % 2048)/16] for on-time samples=[(cnt_chipx1_as % 2048)/16]+128 for half-time samples where, cnt_chipx1_as=0˜5119 start when cnt_chipx1_as=2048

FIG. 5 is a block diagram of a surrounding construction of the sample buffer.

There is a multi-path selector 12, the temporary buffer 14 and an address generator 18 around the sample buffer 5. In this embodiment, the temporary buffer 14 has an 8-chip size and the sample buffer 5 has a 2048-chip size. The multi-path selector 12 selects a path according to the control of the DSP and provides the temporary buffer 14 with samples in an 8-chip period over the selected path. The temporary buffer 14 temporarily buffers the provided samples and then sends the buffered samples to the sample buffer. The sample buffer stores the samples from the temporary buffer 14 using addresses generated in the above-described manner.

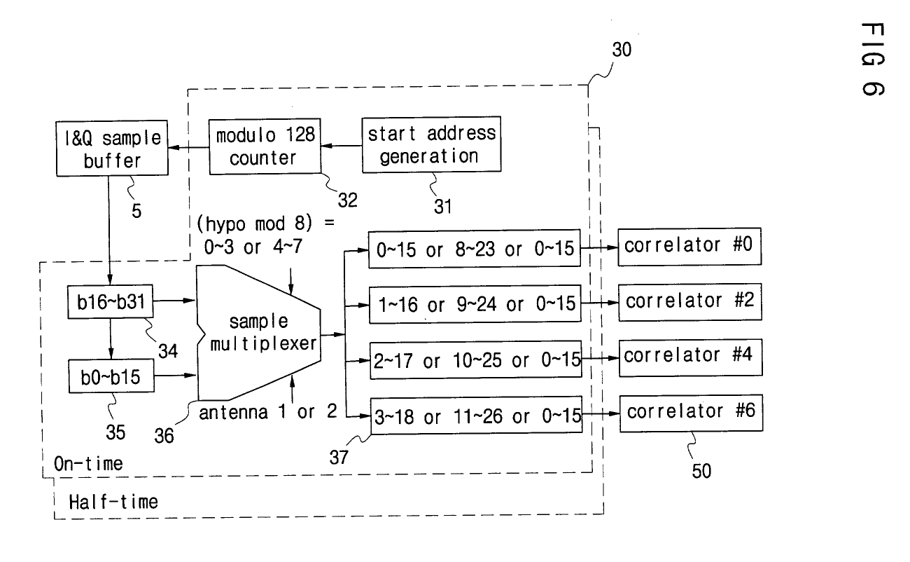

FIG. 6 is a detailed block diagram showing the construction of the sample transmitter 30 of FIG. 2 according to the present invention.

As shown in this drawing, the sample transmitter 30 is constructed with an on-time sample transmitter and half-time sample transmitter. Each of the two sample transmitters includes a start address generator 31, a modulo 128 counter 32, two 16-sample temporary buffers 34 and 35, a sample multiplexer 36, four sample temporary buffers 37. Further, the sample temporary buffers 37 are connected to eight parallel correlators 50 to transmit samples thereto, respectively.

It is required to read samples from the sample buffer 5 for a correlation operation. This read operation begins at the point 2056 (2048+8) chips away from an access slot boundary. After that, an operation to read samples stored in the sample buffer 5 in 16-chip units is performed simultaneously with an operation to store the read samples in 4-chip units. On-time samples and half-time samples are stored in different memory areas, respectively, and each correlation operation is performed independently. Namely, the on-time correlators perform correlation operations with respect to hypotheses #0, #2, #4, #6 (½ chip resolution) and the half-time correlators perform correlation operations with respect to hypotheses #1, #3, #5, #7, respectively. Repeatedly performing these two procedures, the correlators perform correlation operations with respect to the entire hypotheses.

A more detailed description will be given of what described above. The sample transmitter 30 reads samples stored in the sample buffer in order at every clock time and stores read samples in the 16-sample temporary buffers 34 and 35. The sample temporary buffers 37 operate in 1-antenna search mode or 2-antenna search mode. The sample multiplexer 36 performs a multiplexing operation in response to an antenna searching mode select signal and hypothesis select signal.

In the 1-antenna search mode, if hypotheses 0 to 3 are selected, samples b0 to bl5 are stored in correlators #0 and #1, samples b1 to b16 in correlators #2 and #3, samples b2 to b17 in correlators #4 and #5, and samples b3 to b18 in correlators #6 and #7. In the 1-antenna search mode, if hypotheses 4 to 7 are selected, samples b8 to b23 are stored in correlators #0 and #1, samples b9 to b24 in correlators #2 and #3, samples b10 to b25 in correlators #4 and #5, and samples b11 to b26 in correlators #6 and #7.

On the other hand, if the 2-antenna search mode is selected, since offsets between a plurality of hypotheses are generated using PN codes, all of the samples b0 to bl5 are stored in each of the correlators #0 to #7.

The start address generator 31 generates start addresses to read the samples at every access slot, namely, at 16-chip intervals. The modulo 128 counter 32 generates physical addresses based on the start addresses. On the other hand, the input terminals, or the sample temporary buffers 37 connected to the each of the correlators 50 input samples corresponding to addresses (0 to 15, 1 to 16, 2 to 17, 3 to 18) from every 8-chip period and samples corresponding to addresses (8 to 23, 9 to 24, 10 to 25, 11 to 26) from every 8-chip period, respectively.

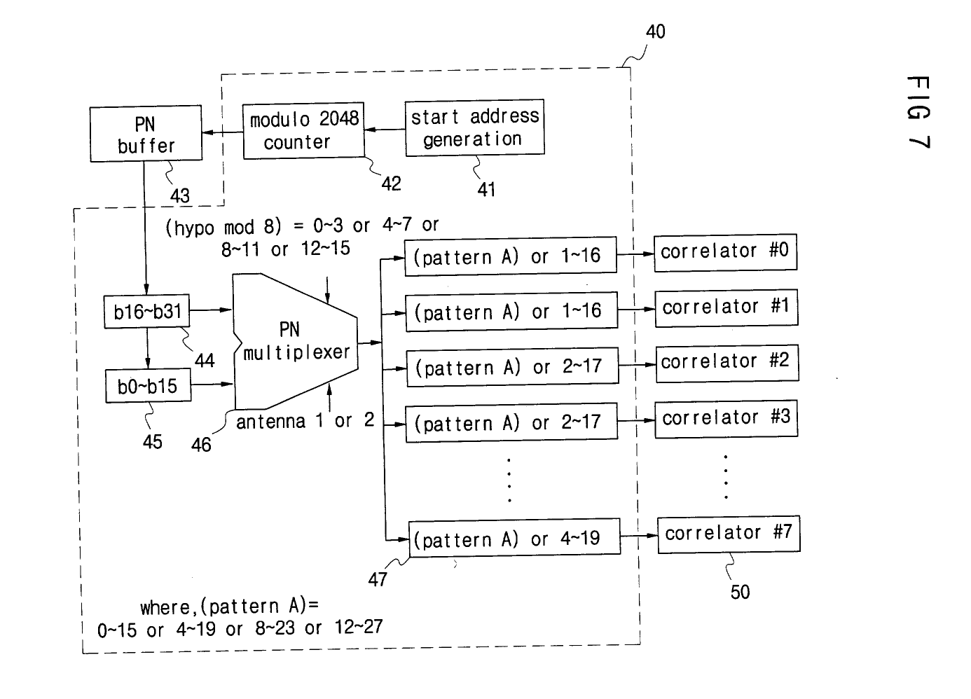

FIG. 7 is a detailed block diagram showing the construction of the scramble code/PN (pseudo noise) code transmitter 40 of FIG. 2 according to the present invention.

As shown in this drawing, the scramble code (PN code) transmitter 40 includes a start address generator 41, a modulo 2048 counter 42, two 16-PN temporary buffers 44 and 45, a PN multiplexer 46 and eight PN temporary buffers 47. Further, each of the PN temporary buffers 47 is connected to eight parallel correlators 50 to transfer code patterns thereto. A PN buffer 43 shown in this drawing corresponds to the scramble code buffer 43 of FIG. 2.

A description will be given of a procedure of generating and storing PN codes. First, scramble codes (PN codes) are updated at every access slot. The correlation operation is not performed at any point in a period of chip 1024 to chip 2048 from an access slot boundary. Therefore, the scramble codes corresponding to a 4096-chip period are generated with a new scramble code seed assigned by the DSP to the chip period (chip 1024 to chip 2048) and stored in the scramble code buffer, or PN buffer 43. This buffer performs a modulo 32 calculation and then stores values corresponding to addresses 0 to 15 in one of its banks and values corresponding to addresses 16 to 31 in the other bank. The PN buffer 43 includes two banks, where each of the banks has a capacity of 128×32 chips.

The PN buffer 43 generates PN codes for the 4096 chips. Therefore, if chip×16 operating clocks are used, 256 (4096/16) chip periods are needed. One PN code corresponding to each chip is generated for a period of 16 operating clocks and stored in the PN buffer 43. PN codes are generated through an operation to write into the PN buffer 43 for a period of chip 1792 to chip 2047 form the access slot boundary and the PN buffer 43 stores the generated PN codes. To generate addresses, first, an initial value 0 is loaded and then increased by one sequentially. As a result, all of the addresses are generated for all 256 rows.

A description will be given of a procedure of reading the PN codes. Samples and the PN codes are used together to adjust an offset. Namely, the samples are used to adjust an offset in period of less than 4 chips and the PN codes are used to adjust an offset in period of 4 chips. Therefore, a correlation operation is completed for one hypothesis at every 8-chip period and the PN buffer 43 has an offset on a 4-chip basis.

The modulo 2048 counter 42 is used to generate the start addresses and quad start addresses, which modulo 2048 counter 42 operates at intervals of an access slot with a time delay of a 2048-chip period. The start address generator 41 generates the start addresses and quad start addresses at every 8-chip period and loads the modulo 2048 counter 42 with them, thereby generating PN addresses at every operating clock. Since each of the quad start addresses has an offset on an 18-chip basis at every row of the PN buffer 43, the PN multiplexer 46 uses an offset select signal to read the PN codes at intervals of 4 chips from the PN temporary buffers 45.

The on-time and half-time correlators share the use of the PN temporary buffers 47. The PN multiplexer 46 operates in response to a 1-antenna searching mode select signal and hypothesis mode select signal. If a 1-antenna searching mode is selected, the same PN patterns stored in the PN temporary buffers 47 are inputted to the correlators 50, respectively. If hypotheses 0 to 3 are selected, b0 to b15 are stored in each of the PN temporary buffers 47; if hypotheses 4 to 7 are selected, b4 to b19 are stored in each of the PN temporary buffers 47; if hypotheses 8 to 11 are selected, b8 to b23 are stored in each of the PN temporary buffers 47; and if hypotheses 12 to 15 are selected, b12 to b27 are stored in each of the PN temporary buffers 47. On the other hand, if a 2-antenna search mode is selected, b1 to b16 are stored in common in the correlators #0 and #1, b2 to b17 in the correlators #2 and #3, b3 to b18 in the correlators #4 and #5 and b4 to b19 in correlators #6 and #7.

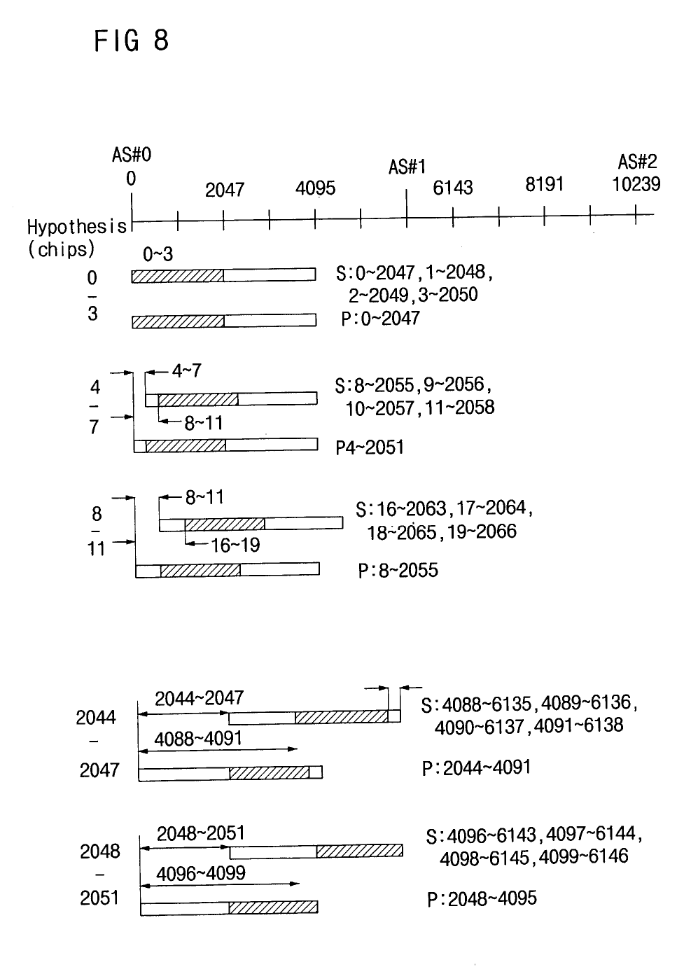

FIG. 8 is a view illustrating a correlation operation between the samples associated with the single antenna and the scramble codes (or PN codes).

Searching 2048-chip hypotheses through the circular buffer, it takes a full 8-chip period to finish correlating the samples with the PN codes for eight hypotheses (½ chip) if the total integration length is a 2048-chip and the eight parallel correlators 50 are used for this correlation operation. Therefore, the samples are shifted in 8-chip units and the PN codes are shifted in 4-chip units.

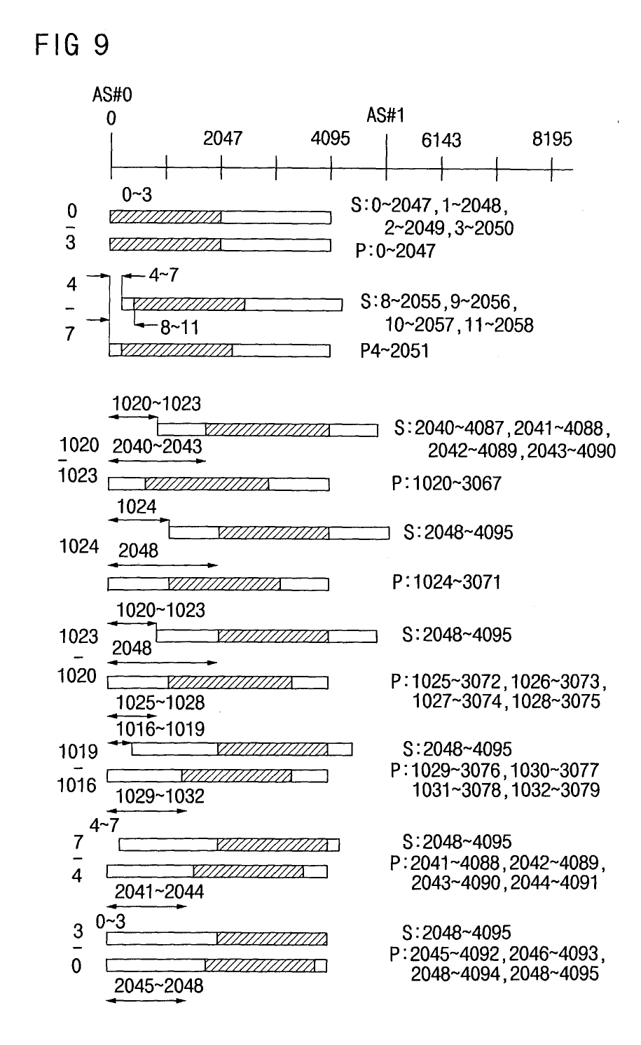

FIG. 9 is a view illustrating a correlation operation between samples associated with two antennas and scramble codes. A preamble search operation in the 2-antenna search mode is performed through the same number of searchers as that used in the preamble search operation in the 1-antenna search mode and, therefore, the number of hypotheses per antenna decreases by half. In the search operation associated with a first antenna of the two antennas, the same sample buffer 5 and PN buffer 43 used for the search operation in the 1-antenna search mode are also used for the search operation associated with the first antenna. The fixed samples in a 2048-chip period are used to perform the search operation associated with a second antenna of the two antennas and the PN offset is used to adjust the offset between different hypotheses. In FIG. 9, the first search shows a correlation of an offset chip period of 0-chip to 1023-chip and the second search shows a correlation of offset chip period of 1023-chip to 0-chip. Note that it is possible to perform a correlation operation for an offset 1024 chips but this correlation operation is not performed in the present invention.

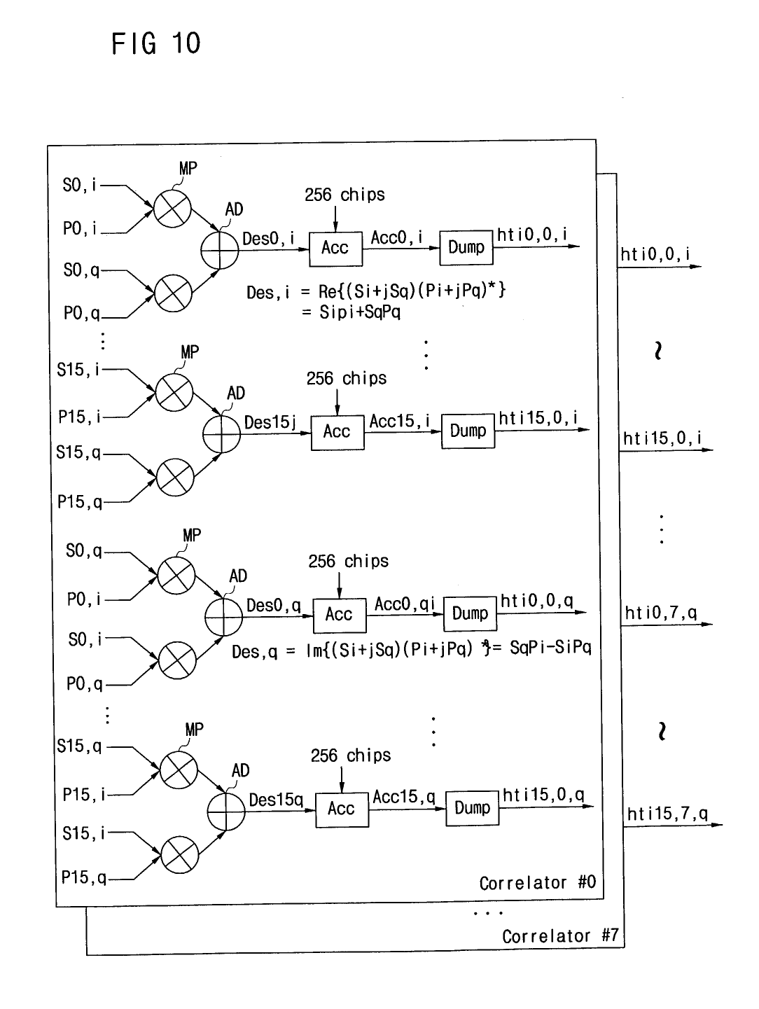

FIG. 10 is a detailed block diagram showing the construction of each of the correlators of FIG. 2 according to the present invention. Each of the correlators includes a complex-conjugate multiplier (MP), adder (AD), accumulator (Acc) and dump circuit (Dump) in order to correlate 19 samples (S) with 19 PN codes (P) to perform a descramble operation and coherent integration operation.

Each of the correlators correlates the samples in every 16-chip period with the PN codes in every 16-chip period at one time and then performs the coherent integration for 16 operating clocks, that is, a 256-chip period. Describing the above-mentioned operation in more detail, the multiplier performs a complex-conjugate multiplication of each of the samples and a corresponding PN code. Then, the adder adds the 16 multiplication results and the accumulator stores the results separately according to the components of I and Q. This despread operation is performed on the basis of one operating clock unit with descramble codes and the coherent integration operation is performed at every operating clock, whereas a non-coherent integration operation is performed in 256-chip units, as will be described below. The dump circuit dumps the result values of coherent integration from the accumulator and outputs them.

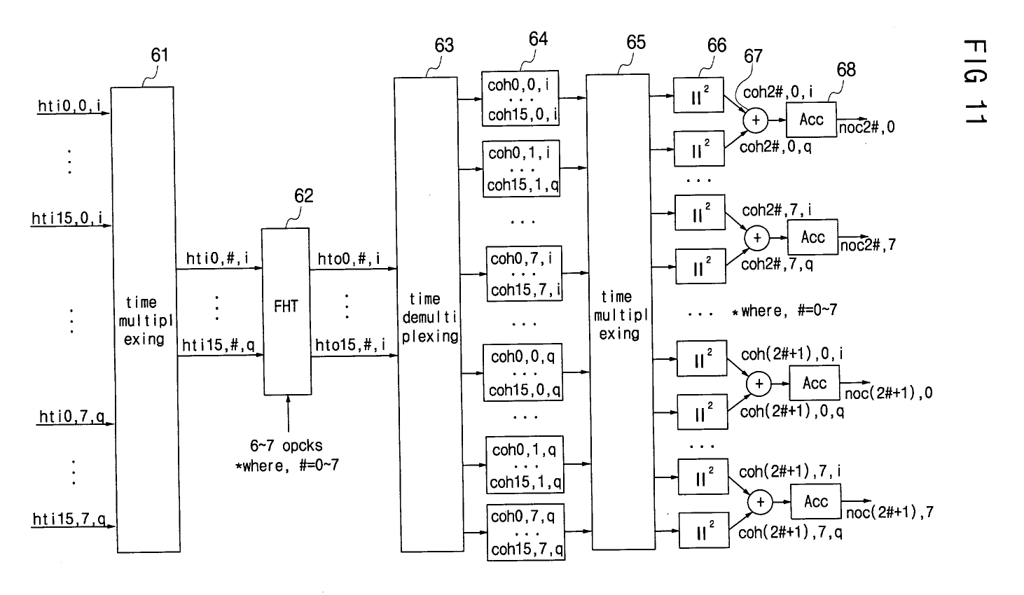

FIG. 11 is a detailed block diagram showing the construction of the energy calculation unit 60 of FIG. 2 according to the present invention.

The energy calculation unit 60 includes an input time multiplexer (256 to 32) 61, a fast Hadamard transform (FHT) unit 62, a time demultiplexer (16 to 32) 63, 32 coherent integration registers 64, a time multiplexer 65, 32 squarers 66, 16 adders 67 and 16 accumulators 68.

First, the input time multiplexer 61 inputs the 16 result values of the coherent integration for each of the I and Q, namely, a total of 32 output values from each of the 8 correlators 50, and outputs them to the FHT unit 62. Then the FHT unit 62 serially performs FHT operations for 16 signatures for 8 hypotheses and stores the results in the coherent integration registers 64. These operations are performed according to the 8 hypotheses, respectively. Next, a square-sum is performed in serial for each of the 8 hypotheses through the time multiplexer 65, squarers 66 and adders 67 for an accumulation of a non-coherent integration, and the resulting accumulated energy is outputted and stored in the accumulator 68. The energy values for the 16 signatures of the 8 hypotheses are respectively calculated by serial processing for the 8 hypotheses with the time multiplexer 65. The energy values for the even and odd signatures of the 8 hypotheses are outputted at the same time.

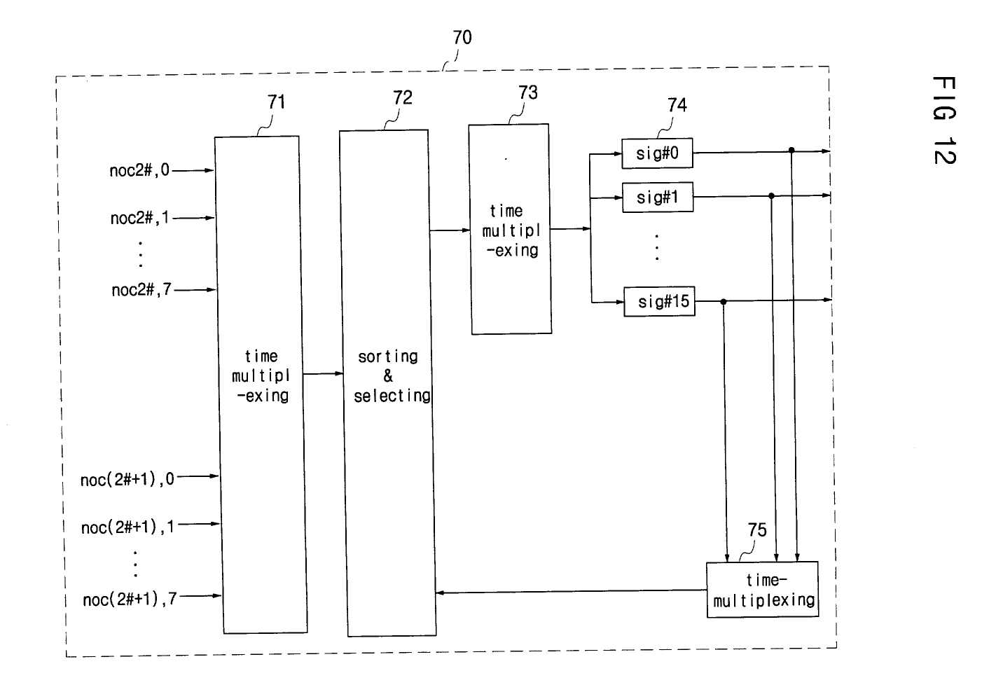

FIG. 12 is a detailed block diagram showing the construction of the sort/select unit 70 of FIG. 2 according to the present invention.

The sort/select unit 70 includes a first time multiplexer 71, sorter/selector 72, a second time multiplexer 73, 16 candidate tables 74 and a third time multiplexer 75.

First, the signatures for the 8 hypotheses are sorted. The energy values of the sorted signatures are respectively compared with current values stored in the candidate tables 74. Then, a signature with the maximum energy value is selected and outputted. The candidate tables 74 are then updated.

The base station transmits a capture indicator responding to the selected signature to the mobile station, thereby establishing a call connection to the mobile station.

Industrial Applicability

As apparent from the above description, the present invention provides a preamble searching apparatus and method which can perform 2048-chip hypothesis search operations instead of 4096-chip hypothesis search operations in the 1-antenna search mode, thereby decreasing the number of searchers by half. Further, the apparatus and method can perform 2048-chip hypothesis search operations using the circular buffer and fixed buffer in the 2-antenna search mode, thereby decreasing the number of the searchers by 75%. As a result, the present invention simplifies a design for a preamble searching core, and therefore has an advantage of decreasing the complexity of the apparatus (matched filer) used for acquiring the initial signal in a CDMA mobile telecommunications system.

Although the present invention has been described in connection with specific preferred embodiments, those skilled in the art will appreciate that various modifications, additions, and substitutions to the specific elements are possible, without departing from the scope and spirit of the present invention as disclosed in the accompanying claims.

1. A method for searching for preambles to acquire a transmitted signal, comprising the steps of:
inputting oversampled samples of each chip associated with a first antenna from an access slot boundary and storing the inputted samples in a first buffer;
inputting oversampled samples of each chip associated with a second antenna after the lapse of a predetermined delay from the access slot boundary and storing the inputted samples in a second buffer;
reading samples in a period of a plurality of chips from the first and second buffers and correlating the read samples with scramble codes to generate signatures corresponding respectively to a plurality of hypotheses;
calculating an accumulated energy value of each of the signatures; and
sorting the signatures by identical ones and selecting one with a maximum accumulated energy value from among the sorted signatures.

2. The method as set forth in claim 1, wherein the first buffer is a circular buffer and the second buffer is a fixed buffer.

3. A method for searching for preambles to acquire a transmitted signal, comprising the steps of:
inputting oversampled samples of each chip associated with an antenna from an access slot boundary and storing the inputted samples in a sample buffer;
reading samples in a period of a plurality of chips from the sample buffer and correlating the read samples with scramble codes to generate signatures corresponding respectively to a plurality of hypotheses;
calculating an accumulated energy value of each of the signatures; and
sorting the signatures by identical ones and selecting one with a maximum accumulated energy value from among the sorted signatures.

4. The method as set forth in claim 3, wherein the sample buffer is a circular buffer.

5. An apparatus for searching for preambles in a mobile telecommunications system employing a code division multiple access system, comprising:
a first buffer for inputting oversampled samples of each chip associated with a first antenna from an access slot boundary and storing the inputted samples circularly for a plurality of correlation periods;
a second buffer for inputting oversampled samples of each chip associated with a second antenna after the lapse of a predetermined delay from the access slot boundary and storing the inputted samples only for a specific one of the correlation periods;
a sample transmitter for reading samples in a period of a plurality of chips from the first and second buffers and transmitting the read samples as a plurality of sample patterns corresponding respectively to a plurality of hypotheses;
a scramble code transmitter for generating scramble codes at intervals of an access slot and transmitting the generated scramble codes as a plurality of scramble code patterns corresponding respectively to the plurality of hypotheses at intervals of the plurality of chips;
a plurality of correlators for correlating the samples from the sample transmitter with the scramble codes from the scramble code transmitter to generate signatures corresponding respectively to the hypotheses;
an energy calculation unit for calculating an accumulated energy value of each of the signatures from the correlators; and
a sort/select unit for sorting the signatures from the correlators by identical ones and selecting one with a maximum accumulated energy value from among the sorted signatures.

6. An apparatus for searching for preambles in a mobile telecommunications system employing a code division multiple access system, comprising:
a sample buffer for inputting oversampled samples of each chip associated with an antenna from an access slot boundary and storing the inputted samples circularly for a plurality of correlation periods;
a sample transmitter for reading samples in a period of a plurality of chips from the sample buffer and transmitting the read samples as a plurality of sample patterns corresponding respectively to a plurality of hypotheses;
a scramble code transmitter for generating scramble codes at intervals of an access slot and transmitting the generated scramble codes as a plurality of scramble code patterns corresponding respectively to the plurality of hypotheses at intervals of the plurality of chips;
a plurality of correlators for correlating the samples from the sample transmitter with the scramble codes from the scramble code transmitter to generate signatures corresponding respectively to the hypotheses;
an energy calculation unit for calculating an accumulated energy value of each of the signatures from the correlators; and
a sort/select unit for sorting the signatures by identical ones and selecting one with a maximum accumulated energy value from among the sorted signatures.
